(19) United States
(12) Patent Application Publication
(10) Pub. No.: US 2007/0044034 A1
(43) Pub. Date: Feb. 22, 2007

(54) Graphical user interface device and method for security application rack

(75) Inventor: Ian M. Nieves, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Metavize, Inc., San Mateo, CA (US)

(21) Appl. No.: 11/349,588

(22) Filed: Feb. 7, 2006

Related U.S. Application Data
(60) Provisional application No. 60/651,003, filed on Feb. 7, 2005.
(60) Provisional application No. 60/765,872, filed on Feb. 6, 2006.

(51) Int. Cl. G06Q 20/00

(52) U.S. Cl. 715/771; 705/22

(57) ABSTRACT

Graphical user interface device and method for security application rack. The present invention provides a graphical user interface for a network appliance. The interface includes a computing device. The computing device is coupled to a world wide network of computers. The interface also includes a display coupled to the computing device. Additionally, the interface includes a first display portion provided on the display. The first display portion illustrates a virtual rack. The virtual rack is adapted to house one or more network software appliances. The one or more network appliances is deployed to process information from the world wide network of computers. The interface also includes a second display portion provided on the display. The second display portion illustrates a plurality of indications. The indications are associated with respective network appliances to be purchased.

### CROSS-REFERENCES TO RELATED APPLICATIONS

This application claims priority to Provisional Application No. 60/651,003 filed Feb. 7, 2005 and Provisional Application No. (Not Yet Assigned) entitled “Edgeguard Gateway Security Platform”, filed Feb. 6, 2006 (Attorney Docket No. 025795-000500US), commonly assigned and hereby incorporated by reference for all purposes.

### BACKGROUND OF THE INVENTION

This invention relates to computer network systems. More particularly, the present invention provides a technique, including a method and system, for providing modular network solutions in a convenient manner. As merely an example, the present invention is implemented on a wide area network of computers or workstations such as the Internet. But it would be recognized that the present invention has a much broader range of applicability including local area networks, a combination of wide and local area networks and the like.

Telecommunication techniques have been around for numerous years. In the early days, people such as the American Indians communicated to each other over long distances using “smoke signals.” Smoke signals were generally used to transfer visual information from one geographical location to be observed at another geographical location. Since smoke signals could only be seen over a limited range of geographical distances, they were soon replaced by a communication technique known as telegraph. Telegraph generally transferred information from one geographical location to another geographical location using electrical signals in the form of “dots” and “dashes” over transmission lines. An example of commonly used electrical signals is Morse code. Telegraph has been, for the most part, replaced by telephone. The telephone was invented by Alexander Graham Bell in the 1800s to transmit and send voice information using electrical analog signals over a telephone line, or more commonly a single twisted pair copper line. Most industrialized countries today rely heavily upon telephone to facilitate communication between businesses and people, in general.

In the 1990s, another significant development in the telecommunication industry occurred. People began communicating to each other by way of computers, which are coupled to the telephone lines or telephone network. These computers or workstations coupled to each other can transmit many types of information from one geographical location to another geographical location. This information can be in the form of voice, video, and data, which have been commonly termed as “multimedia.” Information transmitted over the Internet or Internet “traffic” has increased dramatically in recent years. In fact, the increased traffic has caused congestion, which leads to problems in responsiveness and throughput. This congestion is similar to the congestion of automobiles on a freeway, such as those in Silicon Valley from the recent “boom” in high technology companies, including companies specializing in telecommunication. As a result, individual users, businesses, and others have been spending more time waiting for information, and less time on productive activities. For example, a typical user of the Internet may spend a great deal of time attempting to view selected sites, which are commonly referred to as “Websites,” on the Internet. Additionally, information being sent from one site to another through electronic mail, which is termed “email,” may not reach its destination in a timely or adequate manner. In effect, quality of service or Quality of Service (“QoS”) of the Internet has decreased to the point where some messages are being read at some time significantly beyond the time the messages were sent.

To ensure the QoS, it is often desirable to offer network applications that are specifically design to perform certain tasks. For example, one network system needs an anti-virus application, and another network system needs a firewall application. Network administrators are often burdened with the task to selecting network applications. While according to convention methods network applications are available as different modules, the processing of purchasing network application module is difficult.

Therefore, it is desirable to have an improved method and system for selling and purchasing network applications.

### BRIEF SUMMARY OF THE INVENTION

This invention relates to computer network systems. More particularly, the present invention provides a technique, including a method and system, for providing modular network solutions in a convenient manner. As merely an example, the present invention is implemented on a wide area network of computers or workstations such as the Internet. But it would be recognized that the present invention has a much broader range of applicability including local area networks, a combination of wide and local area networks and the like.

According to an embodiment, the present invention provides a graphical user interface for a network appliance. The interface includes a computing device. The computing device is coupled to a world wide network of computers. The interface also includes a display coupled to the computing device. Additionally, the interface includes a first display portion provided on the display. The first display portion illustrates a virtual rack. The virtual rack is adapted to house one or more network software appliances. The one or more network appliances is deployed to process information from the world wide network of computers. The interface also includes a second display portion provided on the display. The second display portion illustrates a plurality of indications. The indications are associated with respective network appliances to be purchased.

According to another embodiment, the present invention provides method for offering at least one network appliance for sale. The method includes a step for providing a computing device. The computing device is coupled to a world wide network of computers. The method also includes a step for providing a display coupled to the computing device. In addition, the method includes a step for providing a first display portion on the display. The first display portion illustrates a virtual rack. The virtual rack is adapted to house one or more network software appliances. The one or more network appliances are deployed to process information from the world wide network of computers. The method also includes a step for providing a second display portion on the display. The second display portion illustrates a plurality of indications. The indications are associated with respective network appliance to be purchased.

According to another embodiment, the present invention provides computer program product for a network appliance. The network appliance includes a display and a computing device. The computer device is coupled to a network and configured to execute a plurality of codes. The computer program product includes codes for providing a first display portion on the display. The first display portion illustrates a virtual rack, the virtual rack being adapted to house one or more network software appliances. The one or more network appliances are deployed to process information from the world wide network of computers. The computer program product also includes codes for providing a second display portion on the display. The second display portion illustrates a plurality of indications. The indications are associated with respective network appliance to be purchased.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram illustrating a graphic user interface for a network appliance in according to an embodiment of present invention.

FIG. 1A is a simplified diagram illustrating a graphic user interface as implemented for a network appliance in according to an embodiment of present invention.

FIG. 2 is a simplified diagram illustrating a virtual rack on a graphical interface according to an embodiment of present invention.

FIG. 3 is a simplified diagram illustrating a side bar on a graphical interface according to an embodiment of present invention.

FIG. 4 is a simplified diagram illustrating a face plate on a graphical interface according to an embodiment of present invention.

FIG. 5 is a simplified diagram illustrating a control panel on a graphical interface according to an embodiment of present invention.

FIG. 6 is a simplified diagram illustrating a side bar on a graphical interface according to an embodiment of present invention.

### DETAILED DESCRIPTION OF THE INVENTION

This invention relates to computer network systems. More particularly, the present invention provides a technique, including a method and system, for providing modular network solutions in a convenient manner. As merely an example, the present invention is implemented on a wide area network of computers or workstations such as the Internet. But it would be recognized that the present invention has a much broader range of applicability including local area networks, a combination of wide and local area networks and the like.

Traditionally, network administrators obtain network applications from software packages. For example, to have an anti-virus application for a network, an anti-virus software needs to be installed on a network. Often, the anti-virus software is not compatible with other applications on the network. The purchasing and installation processes are often timing consuming and costly. It is therefore desirable to have a convenient way for network administrators to purchase network applications in a convenient manner.

It is to be appreciated that the present embodiment provides a system and method for purchasing network applications. According to certain embodiments, the present invention provides an easy to use graphical user interface (GUI) for users to purchase network applications over a communication network.

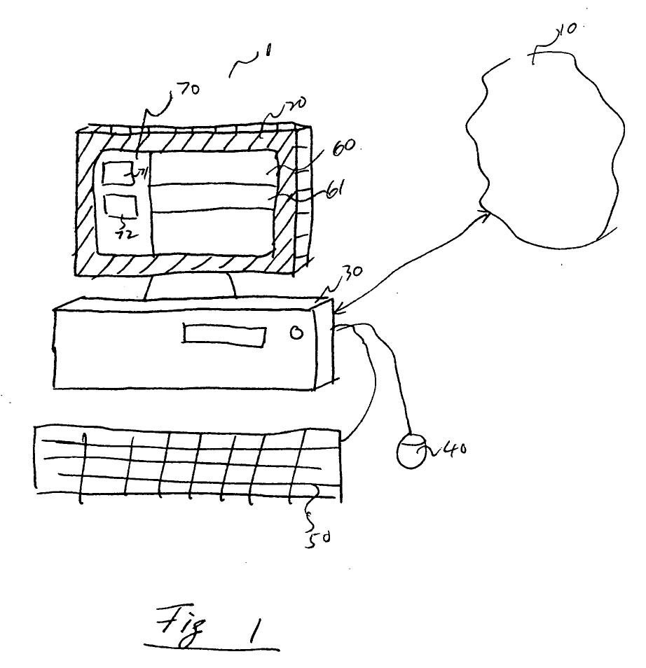

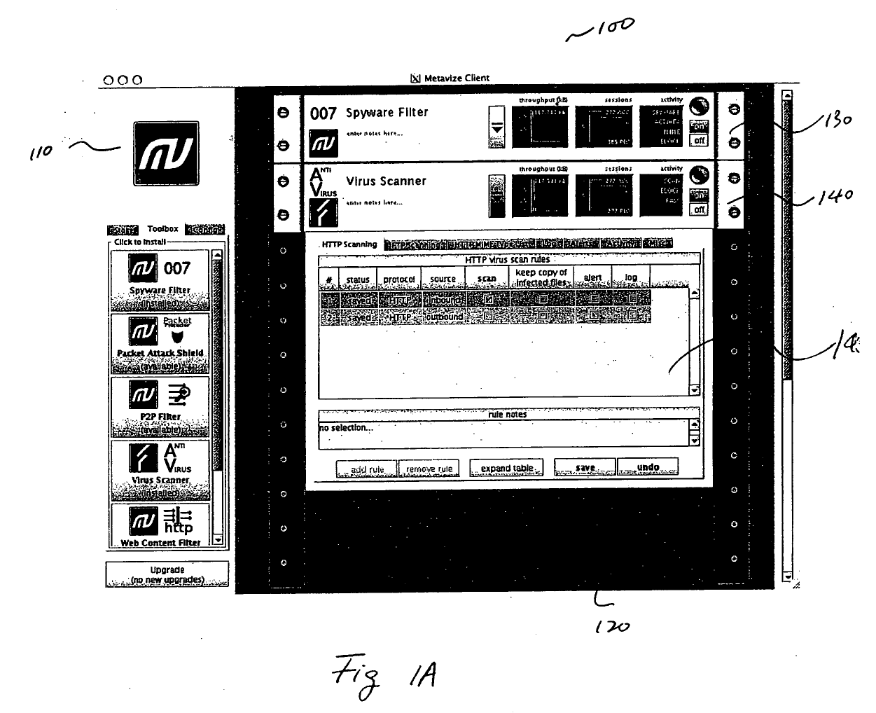

FIG. 1 is a simplified diagram illustrating a graphic user interface for a network appliance in according to an embodiment of present invention. This diagram is merely an example, which should not unduly limit the scope of the claims. One of ordinary skill in the art would recognize many variations, alternatives, and modifications. According to an embodiment, a system 1 for a network appliance includes a display 20, a computing device 30, a keyboard 50, and a mouse 40. For example the system 1 is a computer. The computing device 30 is connect to a network 10. As merely an example, the network 10 is a wide area network, which allows the computing device to access a world wide network of computers. The display 20 is connected to the computing device 30. For example, the display 20 is a computer monitor.

According to an embodiment, the display 20 includes a first display portion 60 and a second display portion 70. The first display portion 60 is used to illustrates a virtual rack. The virtual rack is used to house network appliances, such as anti-virus software, that can be used for network applications. The second display portion 70 is used to illustrates indicators. For example, indicators are clickable buttons for purchasing network appliances.

FIG. 1A is a simplified diagram illustrating a graphic user interface as implemented for a network appliance in according to an embodiment of present invention. This diagram is merely an example, which should not unduly limit the scope of the claims. One of ordinary skill in the art would recognize many variations, alternatives, and modifications. As merely an example, an EdgeGuard™ system provides a graphical interface as shown in FIG. 1A. The graphical interface 100 includes a virtual rack 120 and a side bar 110.

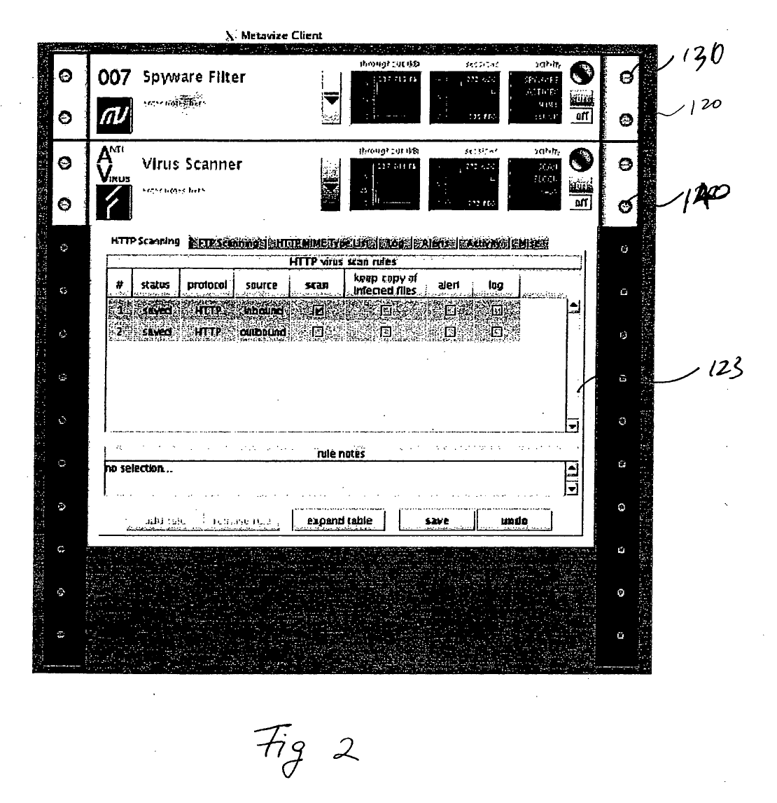

FIG. 2 is a simplified diagram illustrating a virtual rack on a graphical interface according to an embodiment of present invention. This diagram is merely an example, which should not unduly limit the scope of the claims. One of ordinary skill in the art would recognize many variations, alternatives, and modifications. According to an embodiment, the virtual rack is dynamically expandable on the fly to accommodate the addition of new virtual devices, or their removal. For example, a virtual device is a network appliance such as a spyware filter. Merely by way of an example, the virtual rack 120 includes a spyware filter virtual device 130 and a virus scanner virtual device 140. As a part of the graphical interface 100, the virtual device 120 provides network administrator/user a familiar metaphor (racks with rackmount devices) to base their understanding of our user interface upon. The graphical interface 100 thus “feels” more familiar, and thus “feels” less complex, making it easier for a user to choose or purchase a network appliance over a network. As seen on FIG. 2, the virus scanner virtual device 140 has its control panel 123 open, which allows a user to adjust settings associated with the virus scanner virtual device 140.

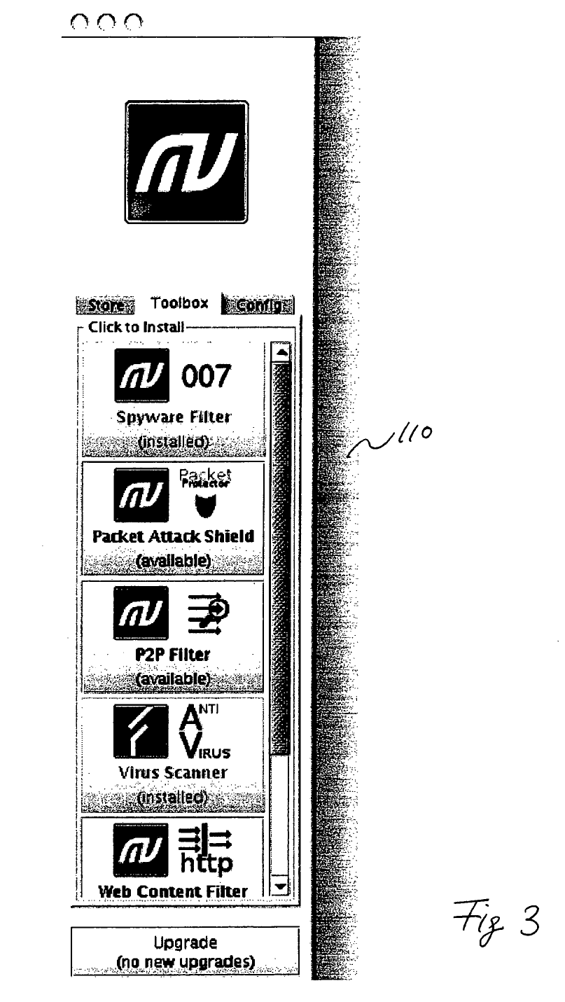

The graphical interface 100 also includes a side bar 110. FIG. 3 is a simplified diagram illustrating a side bar on a graphical interface according to an embodiment of present invention. This diagram is merely an example, which should not unduly limit the scope of the claims. One of ordinary skill in the art would recognize many variations, alternatives, and modifications. According to an embodiment, the side bar 100 is used to configure properties of the overall system and the virtual rack.

It is to be appreciated that the user is able to populate their virtual rack with various virtual network appliances. For example, each virtual network appliance is responsible for implementing a particular aspect of a network security policy. According to certain embodiments, virtual network appliances sometimes may overlap in functionality.

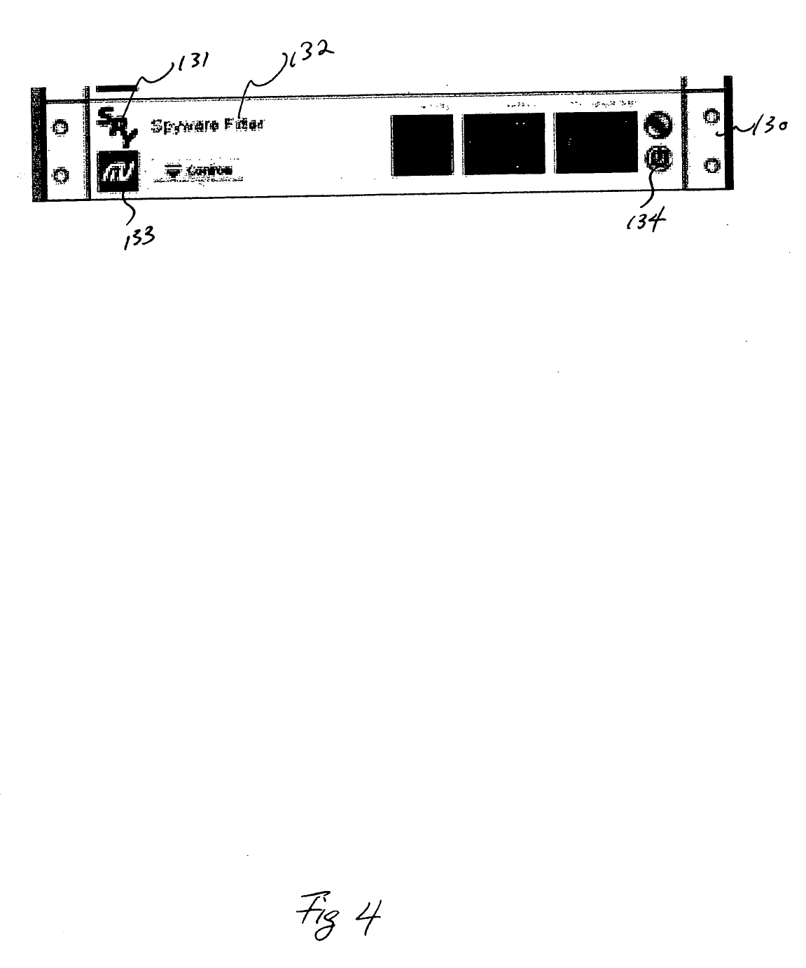

To offer good user interface, each virtual device on the virtual rack 120 has a face plate. FIG. 4 is a simplified diagram illustrating a face plate on a graphical interface according to an embodiment of present invention. This diagram is merely an example, which should not unduly limit the scope of the claims. One of ordinary skill in the art would recognize many variations, alternatives, and modifications. As merely an example, the spyware filter virtual device 130 has a faceplate that serves various function purposes. The face place tells the name of the virtual network appliance in plain text. In this example, the name is “Spyware Filter”. The faceplate also gives an icon 131 to symbolize the functionality of the appliance. In addition, the faceplate gives an icon 133 to symbolize the organization that developed the functionality embodied by the device. Moreover, the faceplate gives a power button 134 which can be used to simply, quickly, and easily enable the functionality of the given appliance, or disable the functionality, in the context of the appliances current configuration. The faceplate additionally gives a colored status indicating LED which can indicate various high level states of the appliance, by blinking or changing color, etc. For example, status may be including ON, OFF, STARTING, STOPPING, FAILURE, WARNING, etc. According to certain embodiments, the faceplate may feature various other smaller colored LED style indicator lights, which can be configured to blink, change intensity, have different color, etc. Indicators can also be used to indicate both state and activity, such as “UNSAVED”, “CONFIGURATION”, “DATA IN”, “DATA OUT”, etc.

It is to be appreciated that the faceplate gives a set of real-time visualizations that the user can read to get a quick sense of the “status/state” of the appliance. For example, the user can notice simple visual trends, such as a lack of activity, or too much activity, etc. This helps give a sense of peace of mind. For example, visualization can be a line graph showing the number of active “sessions” over a 60 second sliding window. In the same graph, in a separate line, we also show the number of session requests. As another example, visualization can be a line graph showing the amount of data (both TCP and UDP) passing through the appliance, in either direction. As yet another example, visualization can be a horizontal bar chart showing relative activity levels in terms of simple key words such as scan, block, pass, etc.

In addition to display useful information, the faceplate also includes useful control features. For example, the faceplate includes control panel button, that when pressed, a control panel/tray slides out and allows the user to configure the settings of the appliance.

It is to be appreciated that according to certain embodiments, the present invention allows customization of the face plate. For example, as shown in FIG. 4, the faceplate for a particular device is set at “1U/high” and is in brushed metal. According to an embodiment, a user can customize the look and size of the appliance to suit our needs. For example, a user can implement a 2U appliance with a red colored plasticky look, so it would stand out from the other appliances in the rack. Such customization can give more room for visualization.

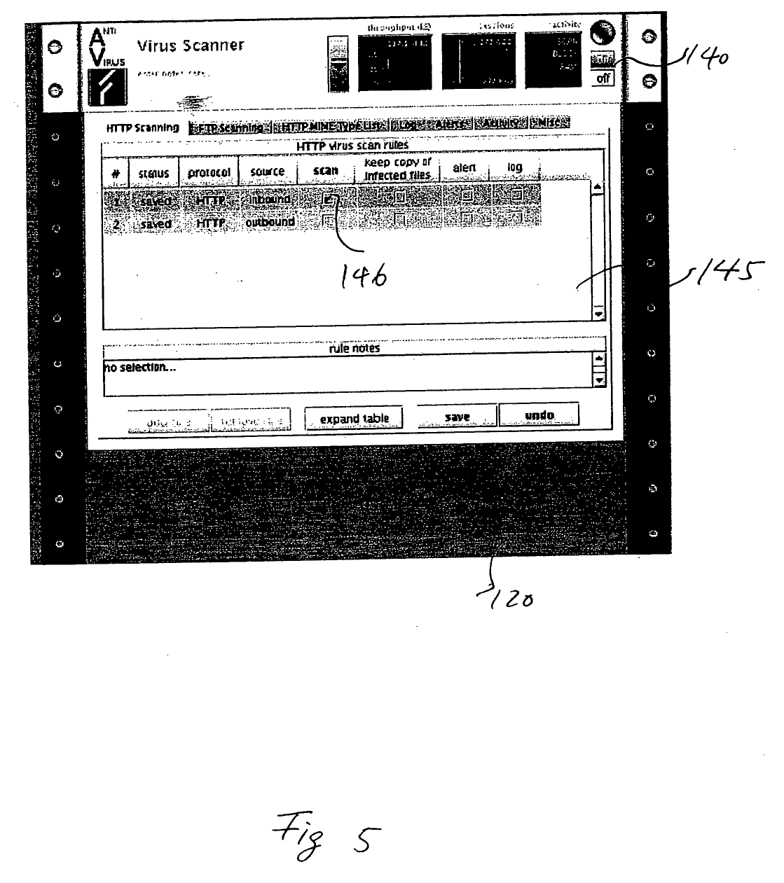

The virtual rack 120 allows an individual appliance to be configured. FIG. 5 is a simplified diagram illustrating a control panel on a graphical interface according to an embodiment of present invention. This diagram is merely an example, which should not unduly limit the scope of the claims. One of ordinary skill in the art would recognize many variations, alternatives, and modifications. As shown in FIG. 5, a control panel 145 is coupled to the virus scanner virtual device 140, and both are display on the virtual rack 120. According to an embodiment, an appliance is configured from within its control panel, which slides out at the press of a button on the faceplate.

It is to be appreciate that a control panel is not limited to control/configuration. Other visualization elements, log readouts, or other tools can be present. According to various embodiments, a control panel is a collection of tabs in a tabbed pane, to make it easy for the user to discover the various configurable aspects of the system. For example, within a tab the user can find a table of rows. The user may add or remove rows from the table at the press of a button. The user may also change the settings within a particular row. As an example, each row is a collection of various UI elements, such as text fields, check boxes, drop down menus, etc.

It is to be appreciated that the control panel, according to certain embodiments, are highly customizable. For example, not all tables have rows that are add/removable. Sometimes the number of rows in the table is static. For example, rows can have their configuration validated, so the user is not able to enter invalid configuration data. According to an embodiment, new settings in the table to not take effect until the user presses a “save” button. A user can hit reload at any point to roll back to the last set of saved settings for a given appliance.

It is also be appreciated that a user has a high degree of freedom in using the graphical interface. For example, it is possible to have settings be saved instantly when the user makes a change. Alternatively, a user is able to create a set of changes, and then “commit”, or save, those changes atomically. Often, because there may not be enough horizontal or vertical room for the entire table, the user can scroll the table around. When a particular row in a table is “clicked in”, detail information is read out in a small text panel just below the table.

According to an embodiment, at the very bottom of the control panel is a set of buttons: “save”, “refresh”, “expand”, and “remove”. For example, by clicking the “save” button, a user commits the possibly changes settings of the appliance. The settings are now stored in non-volatile memory. By clicking the “refresh” button, the user rolls back settings to the last saved settings. The “refresh” button is useful if the user would like to undo a set of settings he was thinking about saving. By clicking the “expand” button, the user is allowed to “tear away” the control panel into a resizable floating modal window. The “expand button” allows the user to “see” more of the configuration at one point. The configuration can then be collapsed to return to its original size/position. Otherwise, the control panel is a fixed size, and can be sometimes too small for managing large data sets. By clicking the “remove” button, the user is allowed to “shut off” the appliance, and remove it from the rack, and put it back into his toolbox. The user can redeploy the appliance later if desired.

According to an embodiment, the table is sortable by column by clicking on the column header. As seen on FIG. 5, there is a “spread check box” button 146 which when pressed, will take the state of the currently selected check box, and apply that state to all the check boxed in the column.

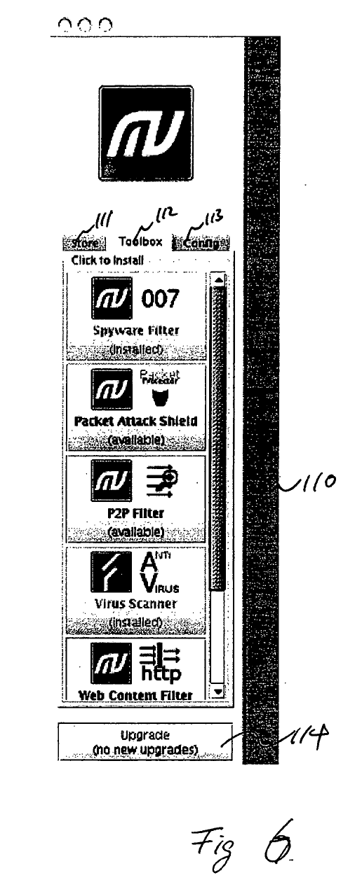

In addition to the virtual rack 120, the side bar 110 is an important feature of the graphical interface 100. FIG. 6 is a simplified diagram illustrating a side bar on a graphical interface according to an embodiment of present invention. This diagram is merely an example, which should not unduly limit the scope of the claims. One of ordinary skill in the art would recognize many variations, alternatives, and modifications. According to an embodiment, the side bar 110 includes 4 key elements: store tabbed pane 111, toolbox tabbed pane 112, configured tabbed pane 113, and upgrade status button 114.

The store tabbed pane 111 shows all of the appliances that the user can purchase. According to an embodiment, a store is dynamically generated per customer, and is connected to a server which. When an appliance is purchased, it goes in the purchasers toolbox. For example, a purchase is made by clicking on the button that represents the desired appliance.

The toolbox tabbed pane 112 shows all of the appliances that the user has purchased, and may now deploy into his rack. According to an embodiment, a appliance is deployed by clicking on the button that represents the desired appliance. By shift-clicking the user is able to “throw away” his license to the appliance, and the appliance will go back into the store for future purchase. Appliances in the toolbox pane 112 are grayed-out if they are currently deployed, otherwise they are in full color. Once an appliance is deployed, it appears in the virtual rack.

According to certain embodiments, each appliance in the store or rack is symbolized as a button which features: an icon symbolizing the functionality of the appliance, an icon symbolizing the organization that developed the appliance, the name of the appliance. An appliance may have various statuses, such as “installed”, “success”, “failed”, “purchase”, etc. According to an embodiment, by a mouse-over the user can read about the appliance.

The configure tabbed pane 113 is a collection of buttons with icons that allow for high level system configuration, such as administrator passwords and logins, directories to map IP addresses to names, etc.

The upgrade status button 114 shows how many upgrades are available online. By clicking the button, the user can begin a manual upgrade process.

It is to be understood FIG. 2-5 are merely examples, which should not unduly limit the scope of the claims. One of ordinary skill in the art would recognize many variations, alternatives, and modifications. For example, the relative positions of the virtual rack and the side bar is top-down instead of side-by-side.

According to an embodiment, the present invention provides a graphical user interface for a network appliance. The interface includes a computing device. The computing device is coupled to a world wide network of computers. The interface also includes a display coupled to the computing device. Additionally, the interface includes a first display portion provided on the display. The first display portion illustrates a virtual rack. The virtual rack is adapted to house one or more network software appliances. The one or more network appliances is deployed to process information from the world wide network of computers. The interface also includes a second display portion provided on the display. The second display portion illustrates a plurality of indications. The indications are associated with respective network appliances to be purchased. For example, the graphical user interface is implemented according to FIGS. 1-6.

According to another embodiment, the present invention provides method for offering at least one network appliance for sale. The method includes a step for providing a computing device. The computing device is coupled to a world wide network of computers. The method also includes a step for providing a display coupled to the computing device. In addition, the method includes a step for providing a first display portion on the display. The first display portion illustrates a virtual rack. The virtual rack is adapted to house one or more network software appliances. The one or more network appliances are deployed to process information from the world wide network of computers. The method also includes a step for providing a second display portion on the display. The second display portion illustrates a plurality of indications. The indications are associated with respective network appliance to be purchased. For example, the method is implemented according to FIGS. 1-6.

According to another embodiment, the present invention provides computer program product for a network appliance. The network appliance includes a display and a computing device. The computer device is coupled to a network and configured to execute a plurality of codes. The computer program product includes codes for providing a first display portion on the display. The first display portion illustrates a virtual rack, the virtual rack being adapted to house one or more network software appliances. The one or more network appliances are deployed to process information from the world wide network of computers. The computer program product also includes codes for providing a second display portion on the display. The second display portion illustrates a plurality of indications. The indications are associated with respective network appliance to be purchased. For example, the computer program product is implemented according to FIGS. 1-6.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A graphical user interface for a network appliance, the graphical user interface comprising:
a computing device, the computing device being coupled to a world wide network of computers;
a display coupled to the computing device;
a first display portion provided on the display, the first display portion being illustrating a virtual rack, the virtual rack being adapted to house one or more network software appliances, the one or more network appliances being deployed to process information from the world wide network of computers; and
a second display portion provided on the display, the second display portion illustrating a plurality of indications, the indications being associated with respective network appliances to be purchased.

2. The graphical user interface of claim 1 wherein the virtual rack comprises a first virtual device.

3. The graphical user interface of claim 2 wherein the first virtual device includes a faceplate.

4. The graphical user interface of claim 2 wherein the first virtual device includes a logo associated with the first virtual device.

5. The graphical user interface of claim 2 wherein the first virtual device includes a plurality of graphical indicators.

6. The graphical user interface of claim 2 wherein the second display portion comprises a side bar.

7. The graphical user interface of claim 1 wherein the virtual rack comprises a third display portion for illustrating a control panel.

8. The graphical user interface of claim 1 wherein at least one of the respective network appliances is purchased by a user of the virtual rack.

9. A method for offering at least one network appliance for sale, the method comprising:
providing a computing device, the computing device being coupled to a world wide network of computers;
providing a display coupled to the computing device;
providing a first display portion on the display, the first display portion being illustrating a virtual rack, the virtual rack being adapted to house one or more network software appliances, the one or more network appliances being deployed to process information from the world wide network of computers; and
providing a second display portion on the display, the second display portion illustrating a plurality of indications, the indications being associated with respective network appliance to be purchased.

10. A computer program product for a network appliance, wherein the network appliance includes a display and a computing device, the computer device being coupled to a network and being configured to execute a plurality of codes, the computer program product comprising:
codes for providing a first display portion on the display, the first display portion being illustrating a virtual rack, the virtual rack being adapted to house one or more network software appliances, the one or more network appliances being deployed to process information from the world wide network of computers; and
codes for providing a second display portion on the display, the second display portion illustrating a plurality of indications, the indications being associated with respective network appliance to be purchased.
